(19) United States
(12) Patent Application Publication
(10) Pub. No.: US 2004/0203385 A1
(43) Pub. Date: Oct. 14, 2004

(54) Session endpoint management method for ad-hoc networks

(76) Inventors: Sathya Narayanan, Plainsboro, NJ (US); Daisaku Komiya, Lawrenceville, NJ (US); Rajesh Khandelwal, Bridgewater, NJ (US)

Correspondence Address: RATNERPRESTIA, P O BOX 980, VALLEY FORGE, PA, 19482-0980, US

(21) Appl. No.: 10/389,422

(22) Filed: Mar. 14, 2003

(51) Int. Cl. H04B 5/00

(52) U.S. Cl. 455/41.2; 455/426.1

(57) ABSTRACT

A method for extending session endpoints in an ad-hoc network environment first performs device discovery to determine local devices within its coverage area and the capability of those devices. These local devices then exchange session descriptions with the endpoint device. If the current session may be supported by one of the local devices, the endpoint device, responsive to a command from an user, transfers the session endpoint to the local device and the endpoint device acts as a proxy for the local device in the session. Optionally, if the local device has a path to the correspondent node that is independent of the path through the endpoint device, it establishes the session along this path and then signal the endpoint node to terminate its session.

### BACKGROUND OF THE INVENTION

The present invention concerns ad-hoc networks and in particular a method for extending or transferring session endpoints in an ad-hoc network environment.

Recent advances in wireless communication technologies coupled with increased capabilities and decreased cost of computer technology have enabled wireless computing applications that had previously been either prohibitively expensive or too bulky for portable devices. Many such applications may be built on a network structures known as mobile ad-hoc networking (MANET). Ad-hoc networks are formed dynamically using groups of mobile computing nodes that have changing connectivity. To operate efficiently, it is desirable for these networks to include the routing functions in each node. Due to the short-range nature of these devices, a communication channel between devices may traverse several intermediate nodes between its source and destination. Because each traversal is known as a “hop,” these networks are referred to as multi-hop networks.

By implementing routing functions in the nodes, these networks allow quick reestablishment of paths between two connecting nodes if an intermediate node can no longer be a part of the network. If, for example, one path between communicating nodes disappears because a device used for one of the hops is no longer able to communicate with other nodes in the group, a secondary path that does not need the missing node may be quickly defined.

Many possible protocols have been defined to implement ad-hoc networking. These include Ad hoc On-Demand Distance Vector (AODV) Routing, Dynamic Source Routing, Optimized Link State Routing and Topology Broadcast Based on Reverse Path Routing. All of these protocols are described on a web-site maintained by the Mobile Ad-Hoc Network working group of the Internet Engineering Task Force (ITEF).

To date, mobility management has been largely concerned with two problems: handoff management and location management. Handoff management concerns the maintenance of an active session between a mobile node and a correspondent node in a mobile network while the mobile node is moving. When a mobile node leaves the coverage area of its current base station to the coverage area of a new base station, handoff between the current base station and the new base station keeps the session active. This problem is addressed by existing protocols, such as the Mobile IP protocol described in RFC 2002.

Location management concerns the problem of locating a mobile node in a network when it is not actively communicating. This may be desirable when, for example, the network receives an incoming call, directed to the mobile node. To solve this problem, the network finds a base station having a coverage area that includes the mobile node. The location management problem has been addressed in IETF protocols, for example, the Mobile IP protocol, referenced above.

### SUMMARY OF THE INVENTION

The present invention is embodied in a method that extends session endpoints in an ad-hoc network environment. An endpoint device using a method according to the subject invention identifies local devices within its coverage area and, optionally, exchanges device capabilities with those devices. These local devices then exchange session description with the endpoint device. If the current session may be supported by one of the local devices, the endpoint device may extend the session endpoint to the local device. The previous endpoint device then acts as a proxy for the local device.

According to one aspect of the invention, if the local device has a path to the correspondent node that is independent of the path through the endpoint device, it may establish the session along this path and then signal the endpoint node to terminate its session.

### BRIEF DESCRIPTION OF THE DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 (prior art) is a block diagram of an Internet protocol (IP) network including a wireless local area network (WLAN) and a mobile device that is useful for describing the environment in which the subject invention operates.

FIGS. 2, 3, 4 and 5 are block diagrams of the IP network shown in FIG. 1 with an ad-hoc network extension that are useful for describing the operation of the subject invention.

FIG. 6 is a flow-chart diagram that is useful for describing the operation of the subject invention.

FIG. 7 is a data structure diagram that is useful for describing possible configurations of a protocol stack suitable for use with the present invention.

### DETAILED DESCRIPTION

The subject invention is embodied in a method that manages session endpoints in an ad-hoc network. By manipulating the endpoint of a session, this method allows a user to achieve device independent communication, allowing a user to select, from a group of available devices in a particular environment, the best device to process the session data. This method does not affect the underlying transport protocol that is used in the session nor does it affect any other protocol that may be used in the session. Parts of the present method may be implemented using other protocols, such as the Bluetooth® device discovery protocol or the Internet Session Description Protocol, both of which are described below. The exemplary method may be implemented at or above the session layer, in the seven-layer Open Systems Interconnection (OSI) model.

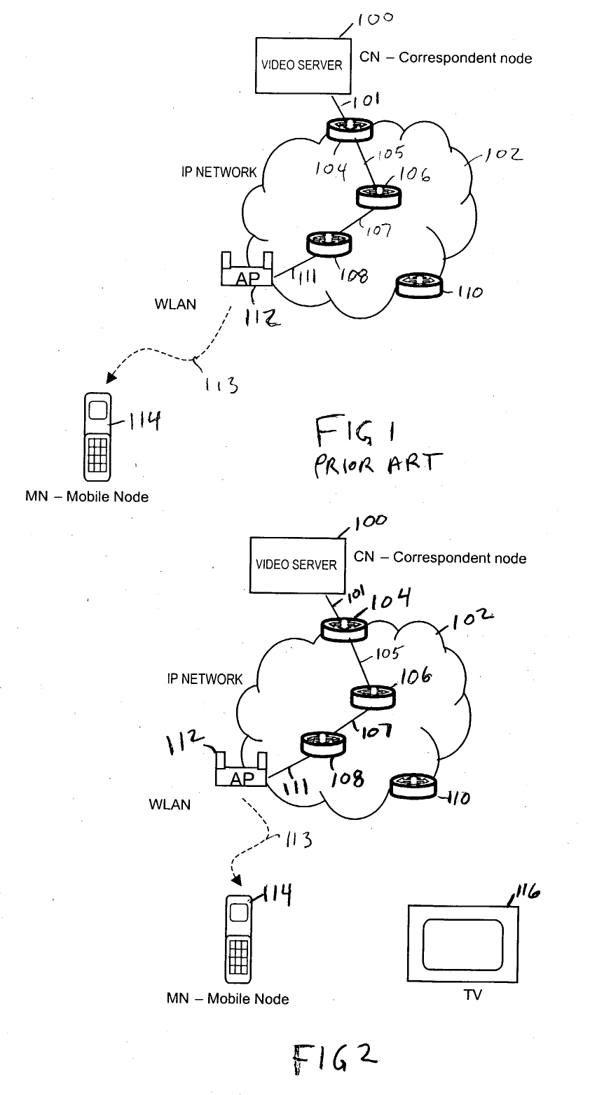

FIG. 1 is a block diagram of an IP network 102 that includes nodes 104, 106, 108 and 110. This network may be wired or wireless. The network also includes an access point 112 through which a wireless device 114, for example, a wireless telephone having video capability may communicate with the network. In the example described below, a video server 100 is also coupled to the network 102, serving as a correspondent node with the mobile note 114. In this example, a session is established between the mobile telephone 114 and the video server 100. The video server 100 provides a video program requested by the mobile telephone 114. To request and provide this program, a connection 101 is established between the correspondent node 100 and node 104 of the network and connections 105, 107 and 111 are established to nodes 106, 108 and the access point 112, respectively. The access point 112 has a wireless connection 113 with the mobile telephone 114. The session established between the video server 100 and the mobile telephone 114 has the telephone 114 as its primary endpoint. According to the method of the subject invention, a secondary endpoint may be established so that the video programming sent to the telephone 114 may be displayed on a more appropriate device.

In FIG. 2, for example, the telephone 114 has moved, while maintaining the connection 113 with the access point 112. In its new position, a television 116, also having a wireless data connection (not shown) is in the coverage area of the telephone 114. Because the television 116 is a more appropriate device for viewing the video program, the user may want to transfer the video signal from the telephone 114 to the television 116. This may be done, for example, by extending the session endpoint from the telephone to the television and configuring the telephone 114 to act as a proxy for the television 116. Before this may be done, however, it is desirable for the telephone 114 and the television 116 to discover each other and to exchange session information to determine whether the television can support the data from the telephone.

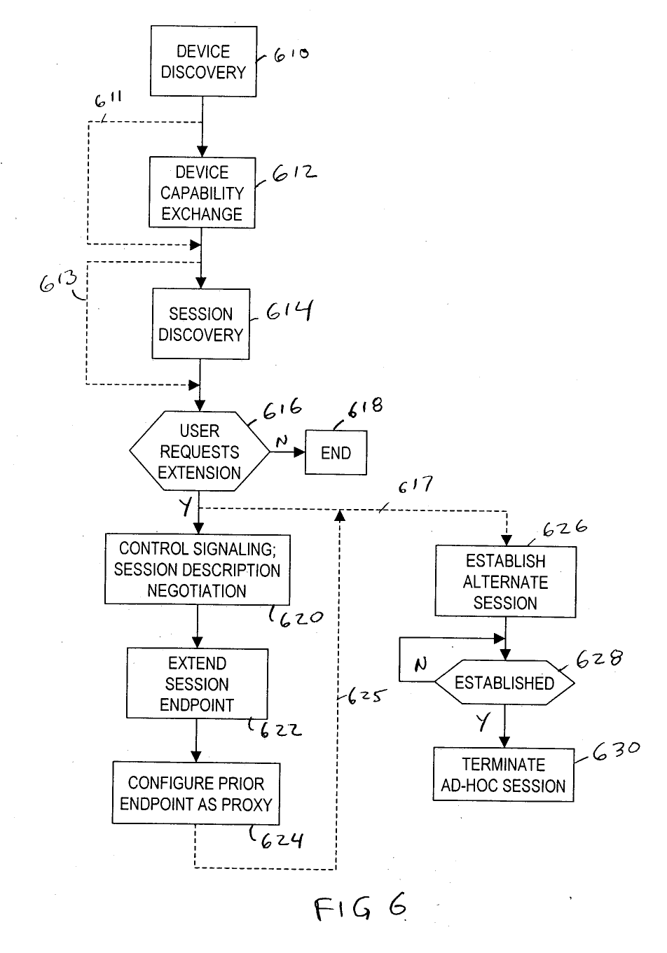

The process of extending the session from the telephone 114 to the television 116 is described with reference to the flow-chart diagram of FIG. 6. In the exemplary embodiment of the invention, both the telephone 114 and the television 116 periodically perform device discovery, step 610 of FIG. 6, to determine which devices are within their coverage areas. In this example, the telephone 114 discovers the television 116 using a device discovery protocol. This protocol, for example, may be the same as the device discovery protocol defined for the Bluetooth® wireless communication standard. Alternatively other device discovery techniques may be used. For example, each device may maintain a device descriptor that contains all relevant information and broadcast the descriptor in response to a request from another device. Alternatively, instead of transmitting a request, each device may simply periodically transmit the descriptor and listen for descriptors transmitted by other devices to determine the properties of devices in its coverage area. According to these methods, device discovery may also include device capability exchange.

If the device discovery performed in step 610 does not include device capability exchange, it may be desirable for the devices to exchange their capabilities as shown in step 612. This exchange transfers one or more packets between the endpoint and at least some of the discovered devices so that the current endpoint node, for example telephone 114, can discover the capabilities of the other devices in its coverage area.

Even if the device discovery performed at step 610 does not include a device capability exchange, it may be skipped, as shown in phantom by the alternate path 611, if, as described below, the information obtained by device capability exchange may be obtained in step 620, the control signaling and session description negotiation step, described below.

In the exemplary embodiment of the invention, each wireless device may periodically broadcast a device discovery request packet. When each device that is within the coverage area receives this request, it synchronizes with the requesting device and transmits a discovery response, containing information about itself, to the requesting device. In the example shown in FIG. 2, when the telephone 114 sends the device discovery request packet, it is received by the television 116 which synchronizes communication with the telephone, to establish a link 115 (shown in FIG. 3) with the telephone and then sends information about itself to the telephone 114. The requesting device records the information it receives in response to a device discovery request in an internal table so that it knows the devices that are within its coverage range and their capabilities. In the Bluetooth system, device discovery is a one-way communication. Each device discovers the devices in its own coverage area independent of the other devices. Thus, in the example shown in FIG. 2, some time after (or before) the telephone 114 discovers the television 116, the television 116 discovers the telephone 114 and any other devices that are within its coverage area. Thus, after step 610, the telephone 114 knows that the television is within its coverage area and vice-versa. As described above, device capability exchange may be a part of the device discovery may be performed in a separate step 612 or may be unnecessary, as indicated by alternate path 612, if it is performed as a part of the device discovery step 610 or if the information used from the device capability exchange may be obtained during the control signaling and session description negotiation step 620, described below.

The session discovery step 614 allows each of the devices to obtain descriptions of any sessions in which the devices within its coverage area are participating. This is implemented in step 612 in which each device requests current session information for each of the devices that have registered with it. Unlike device discovery, currently there is no fixed protocol for session discovery. There are, however, tools that may be used for session discovery. One of these tools is the session description protocol (SDP). This protocol is an Internet standard and is described in request for comments (RFC) 2327. This standard defines session descriptors that are maintained by the device, describing all of the sessions in which it is currently engaged, either as an endpoint or as a transfer node in a multi-hop link. Alternatively other methods may be used to maintain session-specific information in a session descriptor. The exemplary embodiment of the invention implements session discovery by causing the two communicating devices to exchange their session descriptors.

As shown by the phantom connector 613 in FIG. 6, however, the session discovery step 614 is optional. As with the device capability information, the session description may be obtained in the control signaling and session description negotiation step, 620, described below.

After step 614 or steps 612 or 610 if respective the session discovery step 614 and/or device capability exchange step 612 is skipped, step 616 is executed in which the user requests extension of the session. As described below, this extension may be requested reactively from the mobile node 114, or proactively from the mobile node 114, the local node 116 or from another node (not shown) that is not otherwise involved with the transaction. After step 616, if the user does not request the extension, the method ends at step 618. While the present invention is described in terms of a user requesting extension of the session, it is contemplated that this request may also be made by a software agent acting on behalf of the user.

If, however, the user does request extension of the session endpoint, control transfers to step 620 in which control signaling occurs between the mobile node 114 and the local node 116. This step establishes a connection between the mobile node 114 and the local node 116 and then exchanges session descriptions. The control signaling occurs when the connection is established and the session negotiation occurs when the session descriptions are exchanged. After the mobile node receives the session description, it configures itself to receive and appropriately process the data provided by the mobile node. If, for example, the data packets being transmitted represent an MPEG-2 data stream, the television 116 may configure itself to direct the received packets to an MPEG-2 transport decoder.

After step 620, the process shown in FIG. 6 executes step 622 which extends the endpoint from the mobile node 114 to the local node 116. Immediately after extending the endpoint, the mobile node 114 configures itself as a proxy for the local node so that it passes on data packets received from the correspondent node 100 to the local node, but otherwise appears to the correspondent node as the session endpoint.

It is noted that the endpoint extension, described above, is not a transfer of the endpoint but the definition of a secondary endpoint by the primary endpoint. With reference to the example shown in FIG. 3, the correspondent node 100 continues to see the telephone 114 as the endpoint. After establishing the television 116 as the secondary endpoint, telephone 114 acts as a proxy for the television, sending all data that it receives from the correspondent node 100 to the television 116 via the synchronized connection 113.

As described above, the endpoint extension operation may be initiated reactively or proactively. An example of a reactive extension may be when the user enters a room while watching the video content on the mobile telephone 114. Upon seeing the television, the user reactively commands the telephone 114 to extend the session endpoint to the television. This may be done, for example, by pressing a button on the telephone keypad or a touch sensitive area on the telephone display. This reactive step corresponds to step 616 of FIG. 6

An example of a proactive initiation of the endpoint extension may be given as follows. If, after exchanging session descriptions at step 614, the television 116 discovers that the telephone 114 is engaged in a session that is displaying video data, the television 116 may proactively display a message to the user asking whether the session should be accepted. The user's response to this prompt is the result of step 616, described above. Instead of the television proactively displaying the menu, the menu may be displayed in response to the command from the user to transfer the session. This allows the user to confirm the command.

The endpoint extension may also be initiated by a device in the ad-hoc network that is neither the telephone 114 nor the television 116. If, for example, the user has a personal digital assistant (PDA) that is configured as a node in the ad-hoc network, the PDA could be used to directly cause the telephone 114 and television 116 to extend the endpoint of the session or to query the user as to whether the session should be extended from the telephone 114 to the television 116. If the user decides to extend the session, the PDA may initiate the control signaling and session description negotiation of step 620, described above.

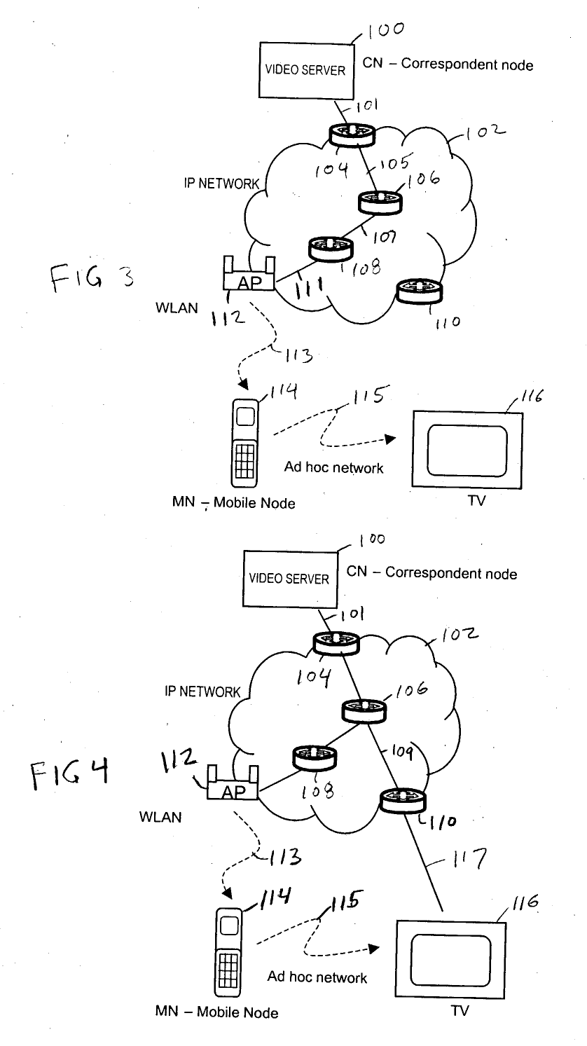

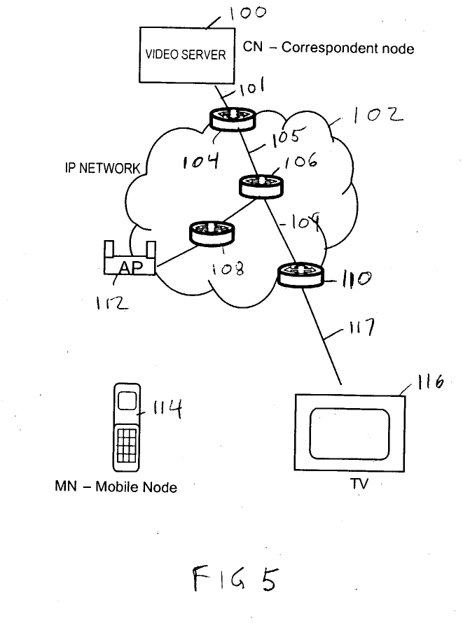

FIGS. 4 and 5 illustrate an alternative embodiment of the invention in which, after or instead of extending the session from the telephone 114 to the television 116, the television 116 discovers that it has a better connection over which it may receive the video data from the correspondent node, sets up the connection and then terminates the session with the telephone 116.

In one exemplary embodiment of the invention, shown in FIG. 4, the television has a high-bandwidth connection 117 to a node 110 in the IP network 102. The television 116, on receiving the session descriptor from the telephone 114 may use another protocol, for example, the Session Initiation Protocol (SIP) to establish links, 117, 109 and 105 to nodes 110, 106 and 106 respectively in order to access the video data directly from the correspondent node, via a new session. SIP is an Internet standard which is described in RFC 3261. Once the new session is established, the television 116 may signal the telephone 114, via the connection 115 to terminate its session with the correspondent node 100. FIG. 5 shows the network after termination of the session.

The method for implementing the endpoint substitution shown in FIGS. 4 and 5 is shown in phantom connectors 617 and 625 and in steps 626, 628 and 630 of the flow-chart diagram of FIG. 6. As shown in FIG. 6, either after step 616 when the user requests session extension, or after step 624 in which the mobile node has been configured as a proxy device, step 626 is executed. In this step, knowing the session information from the telephone 114, the television 116 establishes an alternate session with the correspondent node 100, using, for example, SIP. At step 628, the process waits until the alternate session is established and then, at step 630, signals the telephone 114 to terminate the session.

These steps represent the establishment of a new session between the local device 116 and the correspondent node 100 that is otherwise identical to the session that was previously established between the mobile device 114 and the correspondent node 100. As shown in FIG. 6, this session may be established after step 616 when the devices have exchanged session descriptions but have not yet extended the session endpoint or it may be performed after step 624 when the endpoint has already been extended. According to the first of these options, from the local node 116 establishes its independent session using the session description obtained from the mobile node 114 but before it the endpoint of the original session is extended to the local node. According to the second option, the local node 116 is established as a secondary endpoint and then it establishes it's independent path. This second option may be advantageous as it may reduce the time needed to process the data on the local node. If, for example, the local device has difficulty establishing a connection, there may be significant delays between the user requesting the extension of the session at step 616 and the actual display of data after step 628.

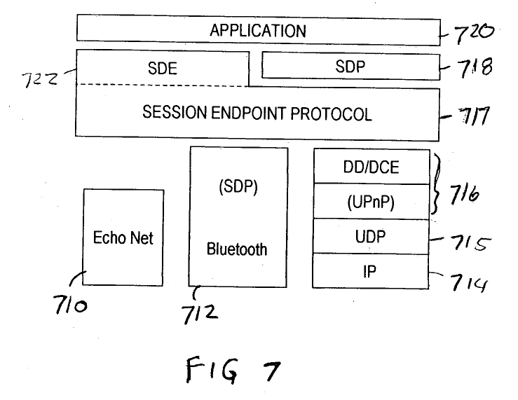

As described above, a method embodying the present invention may be implemented as a part of the application layer defined according to the OSI network model. FIG. 7 shows an exemplary protocol stack that illustrates how the present method may be implemented in an Echo Net™ network 710, a Bluetooth network 712 or an IP network 714. Both Echo Net and Bluetooth have defined transport protocols and are not shown in FIG. 7. The exemplary IP network uses the User Datagram Protocol (UDP) 715 as its transport protocol. UDP is an Internet standard and is described in RFC 768. In the IP network, the transport layer may also include a device discovery or device capability exchange (DD/DCE) protocol 716 that may be used to implement universal plug and play (UpnP). A session endpoint extension method according to the subject invention is above any of these transport protocols as software within the application layer of the device. The application layer may also include a session description exchange (SDE) protocol 722, as described above and/or a session description protocol (SDP) 718. Other applications 720 exist in the application layer above the programs of the present invention in the protocol stack. Although not shown, it is contemplated that the software that implements the session endpoint extension method may include appropriate application program interfaces (API's) to allow the other programs 720 in the application layer to access the features of the session endpoint extension software. As an alternative to implementing the session endpoint extension process in the application layer of the OSI model, it is contemplated that this software may be implemented in the session layer, when the session layer is distinguished from the application layer.

The subject invention may also be used when the “session” that is being extended is entirely within the endpoint node 114. This may occur, for example, in a device having a transducer, in which data is sent from a processor to the transducer. The sending of data from the processor to the transducer may be considered to be a logical session, even though no formal session exists. Using this model, the processor may be considered to be a logical correspondent node and the transducer may be considered to be a logical endpoint. If, for example, the node 114 shown in FIG. 2 were a portable video game having wireless capabilities, it may be considered to be a self-contained logical session which includes both the logical correspondent node (i.e. the processor that executes the video game software) and the logical endpoint (i.e. the video game display). A user, on entering a room may want to display the video game on the television 116 while continuing to use the video game keypad to play the game. According to the present invention, the node 114 could extend its endpoint to transfer data packets to the television so that the game could be displayed on the television instead of on the video game display. Even though no actual session exists, the mobile node 114 may still generate a session description and transfer it to the local node 116 and then begin to transfer the session data to the local node 116 for processing, as described above.

Although the invention has been described in terms of exemplary embodiments, it is contemplated that it may be practiced as described above within the scope of the following claims.

The invention claimed is:

1. A method for managing session endpoints in an ad-hoc network environment including a first device, configured as the primary endpoint of a session between the first device and a correspondent node, and at least one other local device that within a coverage area of the first device, the method comprising the steps of:
determining, by the first device, an identity of the at least one local device;
exchanging session description information with the at least one local device; and
establishing the at least one local device as a secondary endpoint of the session;
whereby the first device acts as a proxy for the local device in the session.

2. A method according to claim 1, wherein the step of determining an identity of the at least one local device includes the step of performing a device discovery operation according to a device discovery protocol.

3. A method according to claim 2, wherein the step of determining the identity of the at least one local device further includes the step of sending, by the at least one local device, device capability data to the first device.

4. A method according to claim 1, wherein the step of determining the identity of the at least one local device includes the step of sending, by the at least one local device, device capability data to the first device.

5. A method according to claim 4, further including the step of determining from the device capability data which of the at least one local devices is capable of serving as the secondary endpoint;
wherein the steps of exchanging session description information with the at least one local device and establishing the at least one local device as a secondary endpoint of the session are performed only for the determined capable devices.

6. A method according to claim 1, wherein the step of exchanging session description information with the at least one local device includes the step of transmitting session description information corresponding to a session description protocol to the at least one local device.

7. A method according to claim 1, wherein the step of establishing the at least one local device as a secondary endpoint of the session includes the steps of:
configuring the at least one local device to receive and process data of the session; and
forwarding, by the first device, the session data to the at least one local device.

8. A method according to claim 7 wherein the step of configuring the at least one local device to receive and process the session data is performed by the at least one local device in response to commands received by the at least one local device from a user.

9. A method according to claim 7 wherein the step of configuring the at least one local device to receive and process the session data is performed by the at least one local device in response to commands received by the at least one local device from the first device.

10. A method according to claim 1, further comprising the steps of:
establishing, by the at least one local device, a further session between the at least one local device and the correspondent node, the further session being independent of the session including the first device; and
terminating the session between the first device and the correspondent node.

11. A method according to claim 10, wherein the further session is established using a session initiation protocol.

12. A method for managing session endpoints in an ad-hoc network environment including a first device, configured as the primary endpoint of a session between the first device and a correspondent node, and at least one other local device that within a coverage area of the first device, the method comprising the steps of:
determining, by the first device, an identity of the at least one local device;
exchanging device capability information with the at least one local device; and
establishing the at least one local device as a secondary endpoint of the session;
whereby the first device acts as a proxy for the local device in the session.

13. A method according to claim 12, wherein the step of determining an identity of the at least one local device includes the step of performing a device discovery operation according to a device discovery protocol.

14. A method according to claim 12, further including the steps of:
determining from the device capability information at least one target local device of the at least one local device which at least one target local device is capable of serving as the secondary endpoint; and
exchanging session description information with the at least one target local device before establishing the at least one target local device as a secondary endpoint of the session.

15. A method according to claim 14, wherein the step of exchanging session description information with the at least one target local device includes the step of transmitting session description information corresponding to a session description protocol to the at least one target local device.

16. A method according to claim 12, wherein the step of establishing the at least one target local device as a secondary endpoint of the session includes the steps of:
configuring the at least one target local device to receive and process data of the session; and
forwarding, by the first device, the session data to the at least one target local device.

17. A method according to claim 16 wherein the step of configuring the at least one target local device to receive and process the session data is performed by the at least one target local device in response to commands received by the at least one target local device from a user.

18. A method according to claim 16 wherein the step of configuring the at least one target local device to receive and process the session data is performed by the at least one target local device in response to commands received by the at least one target local device from the first device.

19. A method according to claim 12, further comprising the steps of:
establishing, by the at least one local device, a further session between the at least one local device and the correspondent node, the further session being independent of the session including the first device; and
terminating the session between the first device and the correspondent node.

20. A method according to claim 19, wherein the further session is established using a session initiation protocol.

21. A method for managing session endpoints in an ad-hoc network environment including a first device, configured as the primary endpoint of a session between the first device and a correspondent node, and at least one other local device that within a coverage area of the first device, the method comprising the steps of:
determining, by the first device, an identity of the at least one local device;
exchanging session description information with the at least one local device; and
establishing, by the at least one local device, a further session between the at least one local device and the correspondent node, the further session being independent of the session including the first device; and
terminating the session between the first device and the correspondent node.

22. A method according to claim 21 wherein the further session is established using a session initiation protocol.

23. A method for managing an endpoint of a logical session in a first device to selectively extend the endpoint to at least one other local device that within a coverage area of the first device, the method comprising the steps of:
determining, by the first device, an identity of the at least one local device;
exchanging session description information with the at least one local device; and
establishing the at least one local device as a secondary endpoint of the logical session.

24. A method according to claim 23, wherein the step of determining an identity of the at least one local device includes the step of performing a device discovery operation according to a device discovery protocol.

25. A method according to claim 24, wherein the step of determining the identity of the at least one local device further includes the step of sending, by the at least one local device, device capability data to the first device.

26. A method according to claim 23, wherein the step of determining the identity of the at least one local device includes the step of sending, by the at least one local device, device capability data to the first device.

27. A method according to claim 26, further including the step of determining from the device capability data which of the at least one local devices is capable of serving as the secondary endpoint;
wherein the steps of exchanging session description information with the at least one local device and establishing the at least one local device as a secondary endpoint of the logical session are performed only for the determined capable devices.

28. A method according to claim 23, wherein the step of exchanging session description information with the at least one local device includes the step of transmitting session description information corresponding to a session description protocol to the at least one local device.

29. A method according to claim 23, wherein the step of establishing the at least one local device as a secondary endpoint of the logical session includes the steps of:
configuring the at least one local device to receive and process data of the logical session; and
forwarding, by the first device, the logical session data to the at least one local device.

30. A method according to claim 29 wherein the step of configuring the at least one local device to receive and process the logical session data is performed by the at least one local device in response to commands received by the at least one local device from a user.

31. A method according to claim 29 wherein the step of configuring the at least one local device to receive and process the logical session data is performed by the at least one local device in response to commands received by the at least one local device from the first device.
